(19) United States
(12) Patent Application Publication
(10) Pub. No.: US 2012/0033257 A1
(43) Pub. Date: Feb. 9, 2012

(54) INFORMATION PROCESSING APPARATUS, IMAGE FORMING APPARATUS, CONTROL METHODS THEREOF AND STORAGE MEDIA

(75) Inventor: Takashi OKAZAWA, Tokyo (JP)

(73) Assignee: CANON KABUSHIKI KAISHA, Tokyo (JP)

(21) Appl. No.: 13/196,449

(22) Filed: Aug. 2, 2011

(30) Foreign Application Priority Data
Aug. 3, 2010 (JP) 2010-174565

(51) Int. Cl. G06K 15/02

(52) U.S. Cl. 358/1.15

(57) ABSTRACT

An information processing apparatus that enables generation of an extended setting User Interface (UI) adapted to various classes devices including a device having low display capability and a device having a WEB browser. The information processing apparatus is connected to an image forming apparatus via a network. A function included in the image forming apparatus is discriminated based on processing capability information. Screen information used for setting an extended function is generated depending on the discriminated function. Extended setting information inputted through a screen displayed on the image forming apparatus based on the generated screen information is received. Image processing based on contents of the received extended setting information is applied to print data received from the image forming apparatus. The image processed print data is transmitted to the image forming apparatus.

### BACKGROUND OF THE INVENTION

1. Field of the Invention

The present invention relates to an information processing apparatus, an image forming apparatus, control methods thereof and storage media in a printing system which realizes various processes in the image forming apparatus by using an external information processing apparatus, and more particularly, to an information processing apparatus which performs panel display on an image forming apparatus, the image forming apparatus, control methods thereof and storage media.

2. Description of the Related Art

In recent years, instead of executing an application on a user's own server, a technique referred to as so-called “cloud computing” for using software as a service provided on the Internet has been popularized. In the cloud computing, the service is provided according to the user's request without making the user be conscious of where a program is actually being executed. Use of a cloud computing environment provides a merit that the user can reduce an initial investment for installation of the server, purchase of the application, and the like.

It is considered to apply this cloud computing environment to an MFP (Multi Functional Printer) which can perform functions of copy, FAX, printing, scanning and the like. The MFP in this case is configured to support only basic functions so that cost of the MFP itself can be reduced. In the MFP in this case, a service environment can be realized which gives highly-functional, added value to this MFP by causing one or more server apparatuses (a so-called cloud) existing on the Internet to process additional functions.

As an example in which the MFP and the cloud cooperate with each other, there is an example in a print function, in which the cloud converts job data in a format which is not accepted by the MFP, into a format of print data accepted by the MFP, and then the MFP prints the data. Thereby, the function provided by the MFP can be extended by using the one or more server apparatuses existing on the Internet, without extending the function of the MFP itself, and thus the cost for the MFP can be reduced.

In the above described cloud computing environment, in accordance with in various product specifications/product forms of MFPs, the one or more server apparatuses existing on the Internet need to perform processes corresponding to functions provided by the MFPs. For example, the server apparatus existing on the Internet may perform display on a panel on the MFP.

Moreover, as an electrical equipment system using a conventional cloud computing environment, a system configured by using the cloud computing environment between a stationary video device and a graphical interactive screen display device has been proposed. This system causes a graphical display element storage unit of the graphical interactive screen display device to store display elements constituting an interactive screen. A control unit of the stationary video device generates an operation instruction signal and transmits data constituting a graphical interactive screen and the operation instruction signal to the graphical interactive screen display device when its own operation unit is operated. When receiving this data constituting the graphical interactive screen and the operation instruction signal, the graphical interactive screen generation unit combines the data constituting the graphical interactive screen with display elements corresponding thereto, displays the graphical interactive screen on a graphical display unit, and changes the display on the graphical interactive screen depending on the operation instruction signal.

If the system is configured in this way, there is no need to provide an electrical circuit which generates a user interface screen for function setting, and a user interface screen display panel, for each stationary video device (for example, see Japanese Laid-Open Patent Publication (Kokai) No. 8-30802).

In a field of products such as a personal digital assistant and a large screen TV, if selection of display content is controlled depending on a display capability, it is premised that a WEB browser has been installed, and that a display function for enabling display of color bitmaps in a certain resolution is included.

In contrast to this, in a case of business machines such as the MFPs, display panels with low display capabilities, such as a 2-line/5-line LCD, may be used, and thus it is necessary to select content which also corresponds to these display panels with the low display capabilities.

Furthermore, basically, the business machines having the 2-line/5-line LCDs may often not have a WEB browser function. Moreover, if the WEB browser (a highly-functional text browser) is installed in devices having panels with the low display capabilities, there is a problem of increased prices of the business machines.

### SUMMARY OF THE INVENTION

Accordingly, the present invention provides an information processing apparatus configured to be connectable to an image forming apparatus via a network, comprising a communication unit configured to transmit and receive data, a discrimination unit configured to discriminate a function included in the image forming apparatus, based on processing capability information received by said communication unit, a generation unit configured to generate screen information used for setting an extended function, depending on the function included in the image forming apparatus which has been discriminated by said discrimination unit, a receiving unit configured to receive extended setting information inputted through a screen displayed on the image forming apparatus based on the screen information generated by said generation unit, from the image forming apparatus, an image processing unit configured to apply image processing to print data received from the image forming apparatus, based on content of the extended setting information received by said receiving unit, and a transmission unit configured to transmit the print data applied with the image processing by said image processing unit, to the image forming apparatus.

Accordingly, the present invention provides an image forming apparatus configured to be connectable to an external apparatus via a network, comprising a communication unit configured to transmit and receive data, a retaining unit configured to retain processing capability information indicating a function included in the image forming apparatus, a first transmission unit configured to transmit the processing capability information retained in said retaining unit to the external apparatus, a receiving unit configured to receive screen information used for setting an extended function, from the external apparatus, a display unit configured to display a screen used for setting the extended function, based on the screen information received by said receiving unit, a second transmission unit configured to transmit extended setting information indicating content of extended setting inputted through the screen displayed on the display unit, and print data, to the external apparatus, and an image forming unit configured to receive print data created by the external apparatus applying image processing to the print data transmitted by said second transmission unit, and perform image forming by using the received print data.

Accordingly, the present invention provides a method of controlling an information processing apparatus configured to be connectable to an image forming apparatus via a network, comprising a communication step of transmitting and receiving data, a discrimination step of discriminating a function included in the image forming apparatus, based on processing capability information received in said communication step, a generation step of generating screen information used for setting an extended function, depending on the function included in the image forming apparatus which has been discriminated in said discrimination step, a reception step of receiving extended setting information inputted through a screen displayed on the image forming apparatus based on the screen information generated in said generation step, from the image forming apparatus, an image processing step of applying image processing to print data received from the image forming apparatus, based on content of the extended setting information received in said reception step; and a transmission step of transmitting the print data applied with the image processing in said image processing step, to the image forming apparatus.

Accordingly, the present invention provides a method of controlling an image forming apparatus configured to be connectable to an external apparatus via a network, comprising a communication step of transmitting and receiving data, a retaining step of retaining processing capability information indicating a function included in the image forming apparatus, a first transmission step of transmitting the processing capability information retained in said retaining step to the external apparatus, a reception step of receiving screen information used for setting an extended function, from the external apparatus, a display step of displaying a screen used for setting the extended function, based on the screen information received in said reception step, a second transmission step of transmitting extended setting information indicating content of extended setting inputted through the screen displayed in said display step, and print data, to the external apparatus, and an image forming step of receiving print data created by the external apparatus applying image processing to the print data transmitted in said second transmission step, and performing image forming by using the received print data.

The features and advantages of the invention will become more apparent from the following detailed description taken in conjunction with the accompanying drawings.

### BRIEF DESCRIPTION OF THE DRAWINGS

FIG. 1 is a drawing showing a concept of an example of a network configuration of a printing system using cloud computing according to a first embodiment of the present invention.

FIG. 2 is a block diagram showing an example of hardware configurations of respective external apparatuses on a cloud computing environment of the printing system using the cloud computing according to the first embodiment of the present invention.

FIG. 3 is a block diagram showing an example of hardware configurations of an information processing apparatus and a print processing apparatus in the printing system using the cloud computing according to the first embodiment of the present invention.

FIG. 4 is a block diagram showing an example of a software configuration of the external apparatus on the cloud computing environment of the printing system using the cloud computing according to the first embodiment of the present invention.

FIG. 5 is a block diagram showing an example of a software configuration of the print processing apparatus in the printing system using the cloud computing according to the first embodiment of the present invention.

FIG. 6 is a flowchart describing an initial setting process for an MFP in the printing system using the cloud computing according to the first embodiment of the present invention.

FIG. 7 is a drawing describing an example of a screen for performing network setting for a device in the printing system using the cloud computing according to the first embodiment of the present invention.

FIG. 8 is a flowchart describing a registration process for the external apparatus on the cloud computing environment of the printing system using the cloud computing according to the first embodiment of the present invention.

FIG. 9 is a diagram describing an example of screen display on the MFP in the printing system using the cloud computing according to the first embodiment of the present invention.

FIG. 10 is a sequence diagram showing a process flow to display an extended setting screen in the printing system using the cloud computing according to the first embodiment of the present invention.

FIG. 11 is a flowchart describing a setting UI screen display process in the MFP in the printing system using the cloud computing according to the first embodiment of the present invention.

FIG. 12 is a flowchart describing a process for an extended setting UI screen in the print processing apparatus in the printing system using the cloud computing according to the first embodiment of the present invention.

FIG. 13 is a flowchart describing a process for the extended setting UI screen in the external apparatus in the printing system using the cloud computing according to the first embodiment of the present invention.

FIG. 14 is a sequence diagram showing a process flow from execution of an extended process to execution of printing in the printing system using the cloud computing according to the first embodiment of the present invention.

FIG. 15 is a sequence diagram showing a flow of notifying capability information from the MFP in the printing system using the cloud computing according to the first embodiment of the present invention.

FIG. 16 is a table showing items to be discriminated used for generating extended setting UI information in the printing system using the cloud computing according to the first embodiment of the present invention.

FIG. 17 is a drawing representing a source of menu data used for generating the extended setting UI information, in metadata, in the printing system using the cloud computing according to the first embodiment of the present invention.

FIG. 18 is a drawing showing a function screen data structure in the metadata used for generating the extended setting UI information in the printing system using the cloud computing according to the first embodiment of the present invention.

FIG. 19 is a drawing showing a display example on a display device of the MFP in the printing system using the cloud computing according to the first embodiment of the present invention.

FIG. 20 is a table showing an example of a result of converting the extended setting UI information in the printing system using the cloud computing according to the first embodiment of the present invention.

FIG. 21 is a flowchart showing an extended setting UI screen generation process in the printing system using the cloud computing according to the first embodiment of the present invention.

### DESCRIPTION OF THE EMBODIMENTS

An information processing apparatus and an image forming apparatus in a printing system using cloud computing according to a first embodiment of the present invention will now be described with reference to the drawings.

In the printing system using the cloud computing according to the present embodiment, a process using print job data in a data format which is not accepted by an MFP and a function which is not supported by the MFP are realized by using a cloud. For example, one MFP may not use printing job data in a PDL (Page Description Language) format.

In this case, an external apparatus (cloud) provided as an information processing apparatus such as a server apparatus converts the print job data into a data format which can be accepted by the MFP, and transfers the converted print job data to the MFP, and the printing is performed. In addition, in this MFP, a process for creating additional information such as a bar-code or a ground pattern, synthesizing the additional information and performing the printing is performed by the external apparatus.

Moreover, in this MFP, also with respect to a scan function, a function related to extended setting can be realized by similarly using the external apparatus (cloud) which is the server apparatus. For example, in this MFP, scan data is converted by the external apparatus which is the server apparatus, into another data format which cannot be outputted by the MFP. Furthermore, in this MFP, a process for adding the additional information such as the bar-code or the ground pattern to the scan data is performed by the external apparatus which is the server apparatus.

Moreover, in this MFP, not only job printing performed from a host computer, but also a process which is performed while a panel of the MFP is operated (such as a scan process) is executed by cooperating with the external apparatus which is the server apparatus.

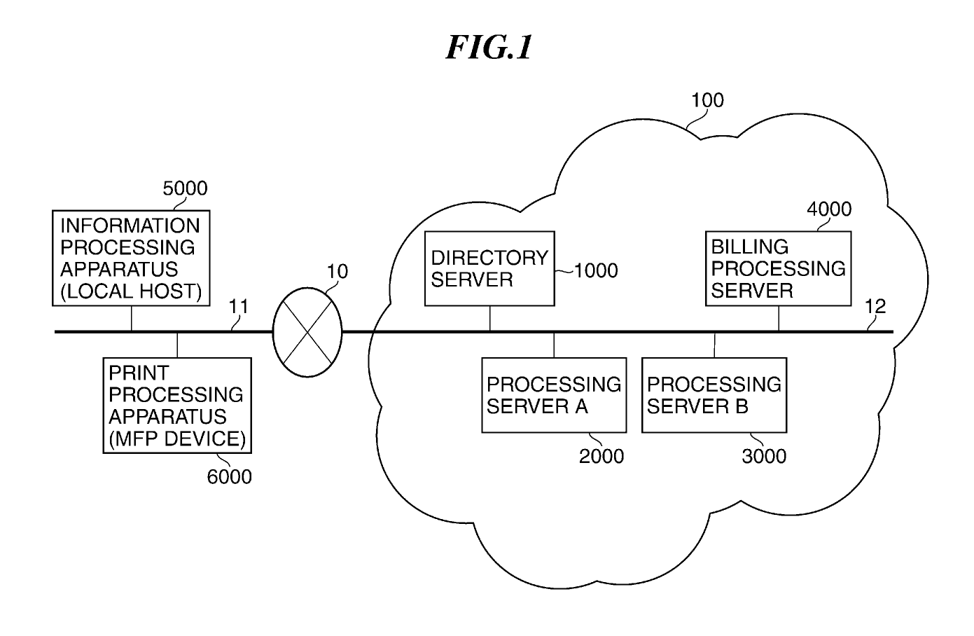

Next, a connection status for respective apparatuses in the printing system using the cloud computing according to the present embodiment will be described with reference to FIG. 1.

In FIG. 1, a local host 5000 as the information processing apparatus such as a local host computer is connected to an MFP 6000 as the image forming apparatus (an print processing apparatus) such as the MFP, through a network or a local interface such as USB.

In addition, the local host 5000 is configured to be connectable to an Internet network via a network interface such as a LAN. Also, the MFP 6000 which is the image forming apparatus is connected to the Internet network via a network interface such as a LAN.

Moreover, as shown in FIG. 1, a cloud 100 is configured to include one or more various server apparatuses (hereinafter, referred to as “external apparatus group”) existing on the Internet. The cloud (external apparatus group) 100 of the present embodiment includes a directory server 1000 which accepts a job from the local host 5000 or the MFP device 6000. Also, the external apparatus group 100 includes a processing server A 2000 and a processing server B 3000 which perform a process depending on setting designated by the job. The respective servers in the external apparatus group 100 are connected to one another via a network 12.

In the printing system using the cloud computing according to the present embodiment, external apparatuses which should be included in the external apparatus group 100 (cloud) are additionally provided corresponding to the number of functions provided by the external apparatus group 100.

Moreover, in the printing system using the cloud computing according to the present embodiment, the local host 5000 and the MFP device 6000 in a user environment are connected to each other via a network 11. In the printing system using the cloud computing according to the present embodiment, the user environment and the external apparatus group 100 are connected to each other via the Internet 10.

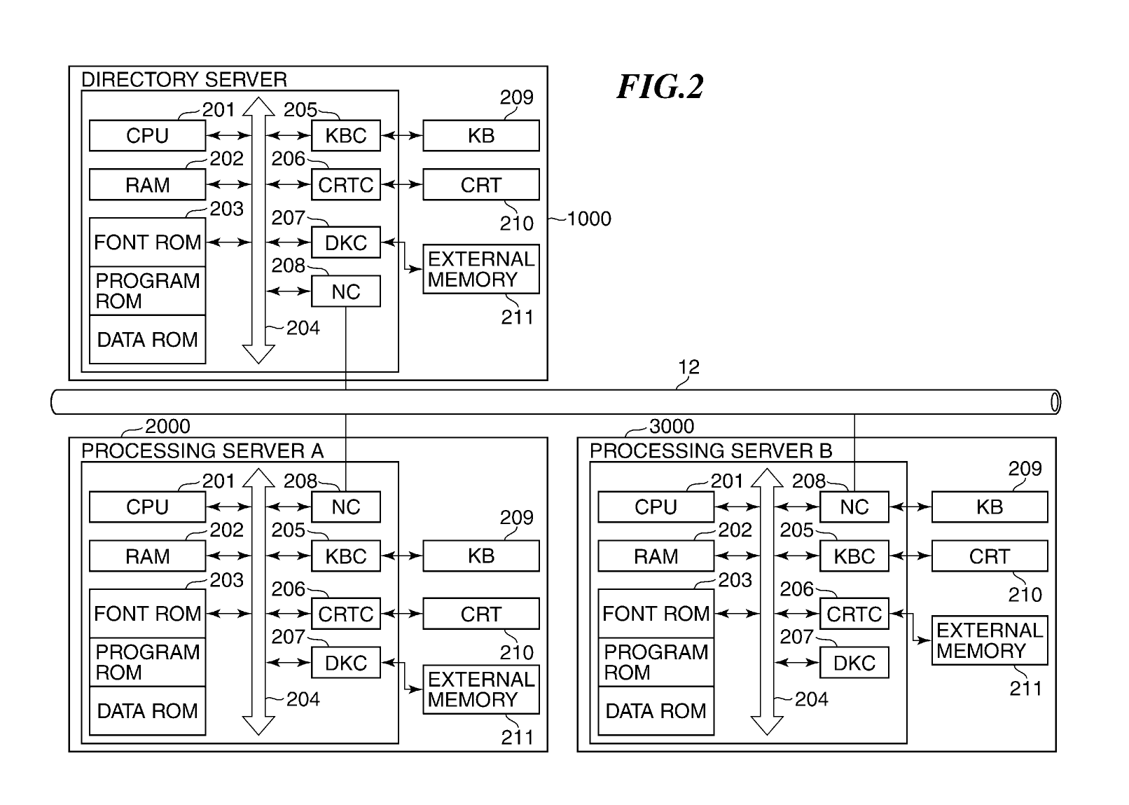

Next, an example of hardware configurations of the external apparatuses (various server apparatuses) in the external apparatus group 100 will be described with reference to FIG. 2.

The directory server 1000 includes a CPU 201. This CPU 201 executes a job allocation process for allocating a job received based on a job acceptance program or the like stored in a program ROM within a ROM 203 or in an external memory 211, to each processing server. Moreover, the CPU 201 controls respective devices connected to a system bus 204, as a whole.

An operating system program which is a control program for this CPU 201, and the like are stored in the program ROM within the ROM 203 connected via the system bus 204, or in the external memory 211.

Various kinds of data used by this CPU 201 for performing the above described job allocation process and the like is stored in a data ROM within the ROM 203, or in the external memory 211.

A RAM 202 which functions as a main memory, a work area and the like is connected to this CPU 201 via the system bus 204.

As shown in FIG. 2, the directory server 1000 includes a keyboard controller (KBC) 205. This keyboard controller (KBC) 205 controls a key input from a keyboard (KB) 209 or a pointing device (not shown).

Moreover, a CRT controller (CRTC) 206 in FIG. 2 controls display of a CRT display (CRT) 210.

A disk controller (DKC) 207 controls access to the external memory 211. This external memory 211 is a hard disk (HD), a floppy disk (FD) (registered trademark) or the like in which a boot program, various applications, a user file, an edited file and the like are stored.

A network controller (NC) 208 is connected to the processing server A 2000, the processing server B 3000 and a billing processing server 4000 via the network. This network controller (NC) 208 executes a process for controlling communication with the processing server A 2000, the processing server B 3000 and the billing processing server 4000.

It should be noted that the hardware configurations of the processing server A 2000 and the processing server B 3000 are similar to that of the above described directory server 1000. However, the processing server is different from the directory server 1000 in that, in the processing server, programs for processes are stored in the program ROM within the ROM 203 or in the external memory 211.

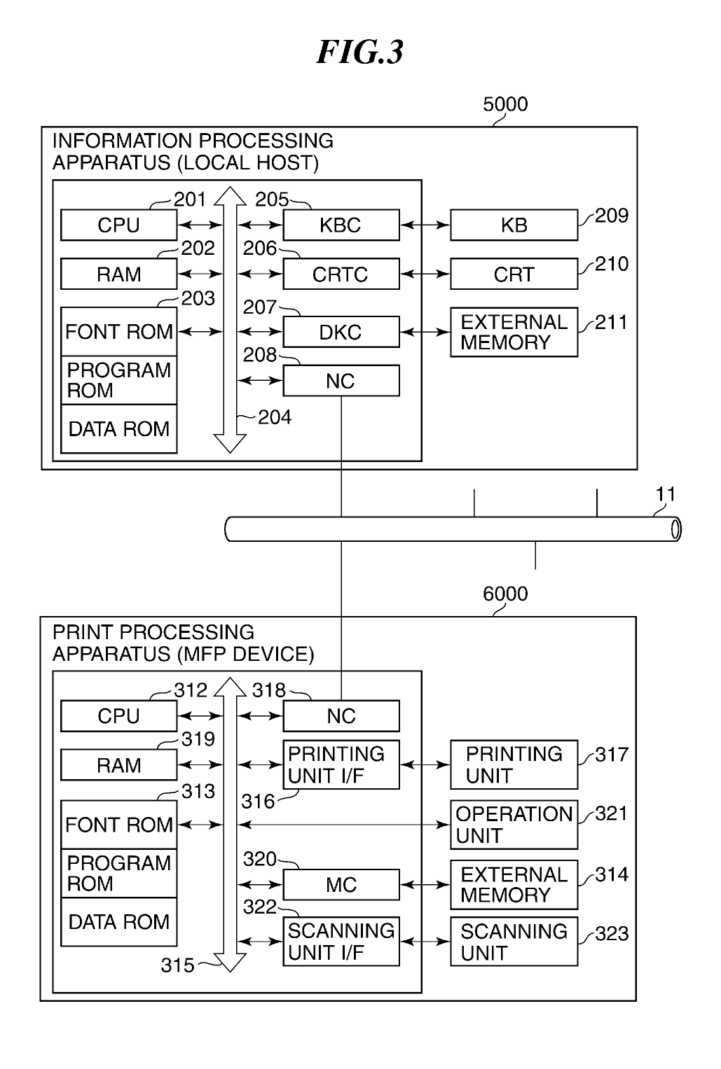

Next, hardware configurations of the local host 5000 and the MFP device 6000 which is the image forming apparatus, in the printing system using the cloud computing according to the present embodiment will be described with reference to a block diagram of FIG. 3.

The local host 5000 as shown in FIG. 3 includes the CPU 201. This CPU 201 executes various processes based on an application program, a printer control command generation program or the like stored in the program ROM within the ROM 203 or in the external memory 211. For example, the CPU 201 executes a process for creating document data in which a graphic, an image, characters, a table (including a spreadsheet or the like) and the like are mixed, and a process for generating a print job for the document data, based on these programs. Moreover, this CPU 201 controls the respective devices connected to the system bus 204, as a whole.

In this local host 5000, the operating system program which is the control program for the CPU 201, and the like are stored in the program ROM within the ROM 203, or in the external memory 211. Moreover, font data and the like used for the above described process for generating the print job for the document data is stored in a font ROM within the ROM 203, or in the external memory 211.

Furthermore, various kinds of data used for performing the document data creation process, the print job generation process and the like as described above is stored in the data ROM within the ROM 203, or in the external memory 211. The RAM 202 functions as the main memory, the work area and the like of the CPU 201.

In FIG. 3 showing this local host 5000, the keyboard controller (KBC) 205 controls the key input from the keyboard (KB) 209 or the pointing device (not shown). Moreover, the CRT controller (CRTC) 206 controls the display of the CRT display (CRT) 210. Furthermore, the disk controller (DKC) 207 controls the access to the external memory 211 such as the hard disk (HD) or the floppy disk (FD) (registered trademark). This hard disk (HD) stores the boot program, the various applications, the font data, the user file, the edited file, the printer control command generation program (hereinafter, “printer driver”) and the like.

In this FIG. 3, the network controller (NC) 208 is connected to the MFP device 6000 which is the image forming apparatus, and the external apparatus group 100 (not shown), via the network. This network controller (NC) 208 executes a process for controlling communication with the MFP device 6000 and the external apparatus group 100 which is the cloud.

It should be noted that the CPU 201 executes, for example, a process for expanding (rasterizing) an outline font onto a display information RAM set on the RAM 202, to enable WYSIWYG on the CRT 210. Moreover, the CPU 201 opens various windows registered based on a command instructed through a mouse cursor (not shown) or the like on the CRT 210, and executes various kinds of data processing.

This the local host 5000 is configured to enable a user to open a window related to print setting and perform setting of the MFP device 6000 which is the image forming apparatus, when the user executes printing.

This MFP device 6000 as shown in FIG. 3 is controlled by a CPU 312. The CPU 312 outputs an image signal as output information to a printing unit 317 via a system bus 315, based on a control program and the like stored in a program ROM within a ROM 313, or a control program and the like stored in an external memory 314.

Moreover, the control program for this CPU 312, and the like are stored in the program ROM within the ROM 313.

Font data used for generating the above described output information, and the like are stored in a font ROM within this ROM 313. Information and the like used on the local host 5000 are stored in a data ROM within this ROM 313, if the device 6000 does not have the external memory 314 such as a hard disk. This external memory 314 is configured to be able to store the user's print data.

The CPU 312 of this MFP device 6000 is configured to be able to perform a communication process with the local host 5000 or the external apparatus group 100 which is the cloud, via a network interface 318. Furthermore, this CPU 312 is configured to be able to transmit information and the like within the device 6000 to the local host 5000 or the external apparatus group 100 which is the cloud, and also receive data from the local host 5000 or the external apparatus group 100.

If a print operation is performed in the MFP device 6000 in this printing system using the cloud computing, job data is received from the host computer 5000. Moreover, if a scan operation is performed in the MFP device 6000, image data is transmitted to the external apparatus group 100 or the host computer 5000. Furthermore, in addition, the MFP device 6000 exchanges a command or a status.

This MFP device 6000 includes a RAM 319 which functions as a main memory, a work area and the like of the CPU 312.

The MFP device 6000 further includes an operation unit 321 configured to include display elements in a system such as LCD (Liquid Crystal Display), and input devices such as a button, a touch panel, a keyboard and a mouse.

This MFP device 6000 is configured to enable the user to issue an instruction for an operation of the MFP device 6000, and confirm a state of the MFP device 6000, through the operation unit 321. Furthermore, this MFP device 6000 displays data on a display device of the operation unit, according to information obtained via the network interface 318. Moreover, this MFP device 6000 is configured to be able to transmit data inputted by the user performing an input operation on the operation unit, to the external apparatus group 100.

As this MFP device 6000, there are devices in various forms including various functions and characteristics. For example, a color MFP includes a key input function with a touch panel, a color LCD display (800×600 VGA) and a numerical keypad. A monochrome MFP includes a key input function with a touch panel, a monochrome LCD display (600×400) and a numerical keypad. A compact MFP-1 includes a key input function with a color LCD display (600×400), a numerical keypad, and up, down, left and right keys. A compact MFP-2 includes a key input function with an LCD display with 20 characters and two lines, a numerical keypad, and up and down keys. A printer-1 includes a key input function with an LCD display with 16 characters and two lines, and up, down, left and right keys. A printer-2 includes only an LED display.

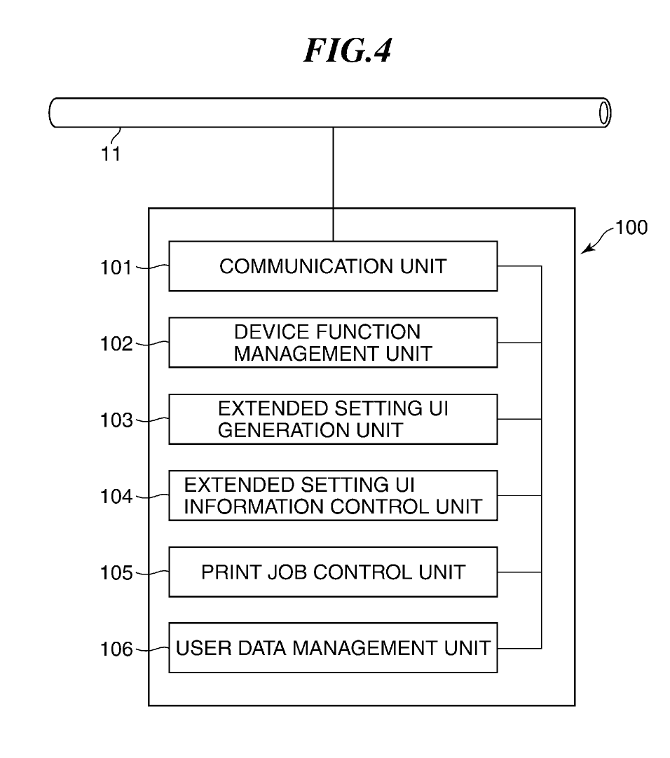

Next, a software configuration included in the external apparatus group 100 (cloud) will be described with reference to a block diagram of FIG. 4.

Each server in the group 100 is a server apparatus connected to a LAN 11. The external apparatus group 100 exchanges packets for transmitting and receiving various kinds of data (performs two-way communication), with the MFP device 6000 and the host computer 5000, via a communication unit 101 connected to the LAN 11. Content of this two-way communication includes the job data, the image data, a command for a job start request or the like, a polling packet for passing through a fire wall, a data packet for controlling UI display, and the like.

A device function management unit 102 of the external apparatus group 100 receives processing capability information on the MFP device 6000 and discriminates a device function. An extended setting UI generation unit 103 of the external apparatus group 100 generates an extended setting UI (user interface) depending on the device function discriminated by the device function management unit 102. An extended setting UI information control unit 104 of the external apparatus group 100 provides extended setting UI information to the MFP device 6000. Moreover, this extended setting UI information control unit 104 receives the extended setting UI information and retains content set therein.

A print job control unit 105 of the external apparatus group 100 receives the print job, applies image processing to this received print job based on the content of the extended setting UI information received by the extended setting UI information control unit 104, and generates print image data. In other words, the print job control unit 105 applies the image processing to the print job received from the MFP device 6000, based on the content of the extended setting UI information retained in the extended setting UI information control unit 104, and generates data for a print process.

Also, the print job control unit 105 transmits the generated image data for the print process to a corresponding MFP device 6000. It should be noted that, although not shown, in a job process activated by the print job control unit 105, a data conversion process and the like are actually executed. For example, in a case of the print job, the job data is converted into the image data.

A user data management unit 106 of the external apparatus group 100 manages a list of the MFP devices 6000 registered for each contract unit using the external apparatus in the external apparatus group 100. For example, in this list, when an external apparatus ID is 00000AAA1026, if a device name is Printer A, then a model is LBP8000, an IP address is 192.168.0.12, and a subnet mask is 255.255.255.0. Moreover, in this list, if the device name is Multifunction Peripheral B, then the model is IR3000, the IP address is 192.168.13.11, and the subnet mask is 255.255.255.0.

The communication unit 101 of the external apparatus group 100 is implemented in the directory server 1000. Furthermore, job processing units are implemented in the processing server A 2000 and the processing server B 3000. Moreover, in the present embodiment, a configuration including one directory server and two processing servers will be described. It should be noted that, in the external apparatus group 100, the servers may be a single integrated server, and the number of the processing servers to be provided may be other than two.

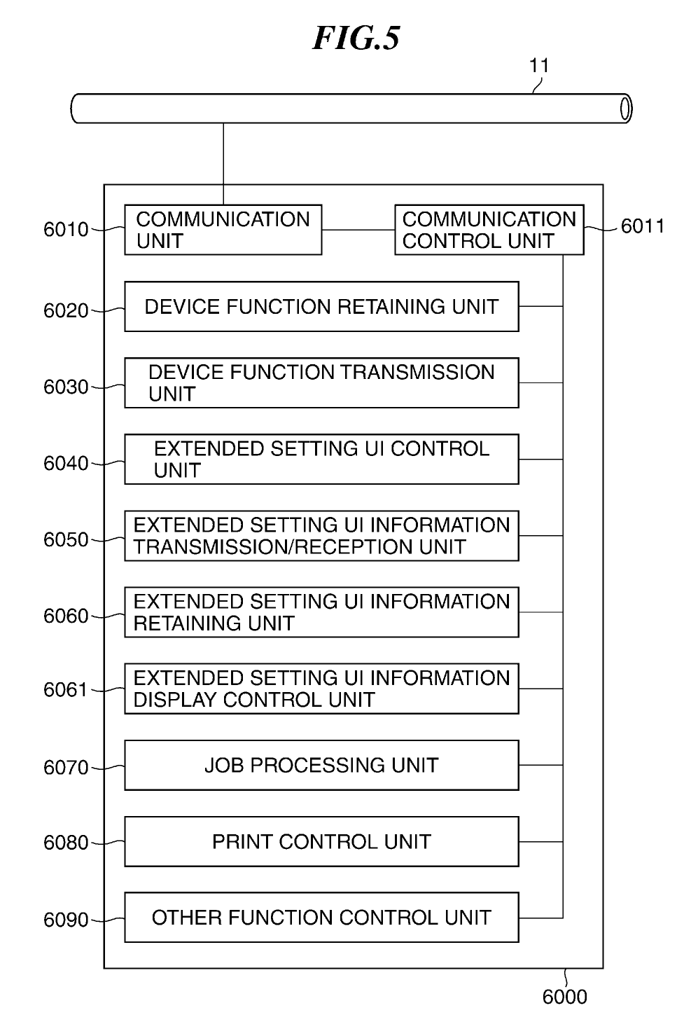

Next, a software configuration of the MFP device 6000 will be described with reference to a block diagram of FIG. 5.

In this MFP device 6000, a communication unit 6010 which is a communication unit connected to the LAN 11, and a communication control unit 6011 perform various kinds of protocol control to thereby perform various kinds of data receiving processes and data transmission processes.

A device function retaining unit 6020 of this MFP device 6000 retains information on functions which can be processed by the device. A device function transmission unit 6030 of this MFP device 6000 transmits the information on functions retained in the device function retaining unit 6020 to outside of the device. An extended setting UI control unit 6040 of this MFP device 6000 requests the external apparatus in the external apparatus group 100 to provide data of the extended setting UI, for performing display on the device. Moreover, the extended setting UI control unit 6040 transmits data of a UI capability of this MFP device 6000 to the external apparatus.

An extended setting UI information transmission/reception unit 6050 of this MFP device 6000 receives the extended setting UI information from the external apparatus group 100. This received extended setting UI information is stored and retained in an extended setting UI information retaining unit 6060.

Moreover, an extended setting UI information display control unit 6061 of this MFP device 6000 performs display based on the received extended setting UI information, and also transmits an input result from a display unit, to the external apparatus group 100 through the extended setting UI control unit.

A job processing unit 6070 of this MFP device 6000 receives and processes the print job and jobs for FAX and the like. Image data for FAX, copy or printing which has been generated in this job processing unit 6070 is applied with a print process by a print control unit 6080. Furthermore, the print control unit 6080 executes the print process for the received print image data. It should be noted that an other function control unit 6090 of this MFP device 6000 is a part which executes functions as the MFP.

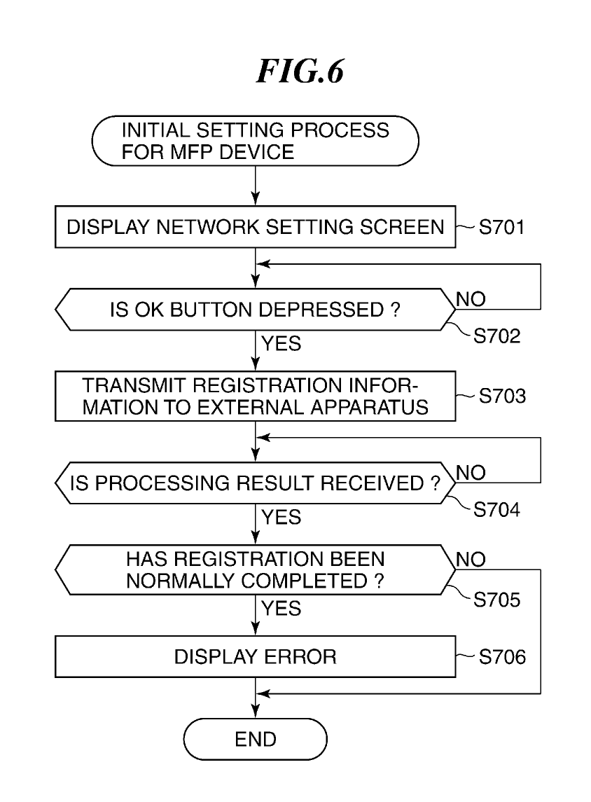

Next, a procedure of an initial setting process for the MFP device 6000 will be described with reference to a flowchart of FIG. 6.

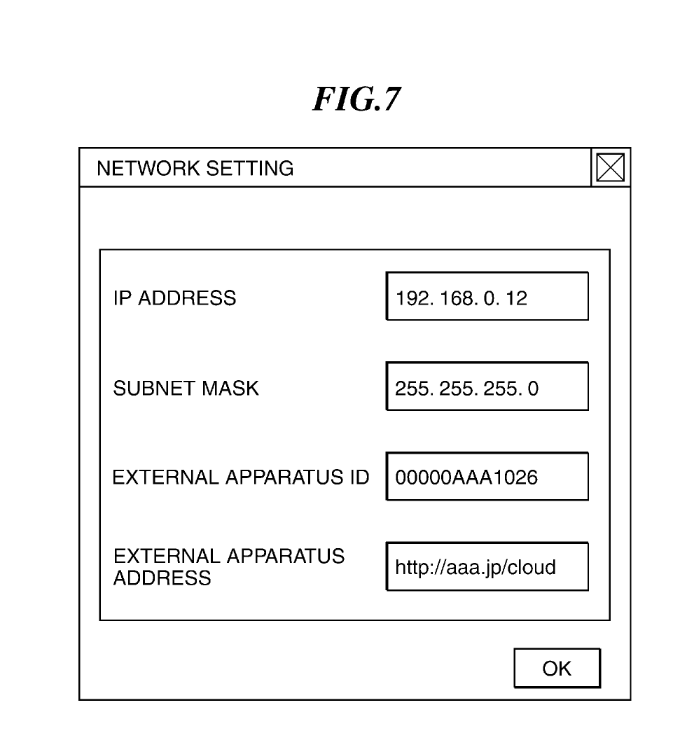

This initial setting process starts when the MFP device 6000 is activated. First, the CPU 312 of the MFP device 6000 controls to display a network setting screen as shown in FIG. 7 (step S701).

Here, the user uses the network setting screen as shown in FIG. 7 to perform setting of the network for using each external apparatus in the external apparatus group 100. The user inputs an IP address, a subnet mask, and an ID for using the external apparatus, as specific network setting information, and depresses an OK button to decide input items.

When detecting that the OK button is depressed in step S702, the CPU 312 of the MFP device 6000 proceeds to step S703. Then, the CPU 312 stores the setting information in a storage area of the MFP device 6000, and simultaneously transmits the input information to the external apparatus in the external apparatus group 100 (step S703). Here, the information to be transmitted is configured to include a device name, a kind of the device, the IP address, the subnet mask, the device ID and the like.

Next, the CPU 312 of the MFP device 6000 waits for a notification indicating a result of a registration process in the external apparatus in the external apparatus group 100 (NO in step S704). Then, if the above described notification arrives (YES in step S704), the CPU 312 discriminates whether or not content of the notification indicates that the registration has been normally completed. If it is discriminated that the registration has been normally completed (YES in step S705), the CPU 312 completes the initial setting process. Moreover, if it is discriminated that the registration has not been normally completed (NO in step S705), the CPU 312 proceeds to step S706.

Next, the CPU 312 displays an error indicating that the registration has not been normally completed, and then completes this initial setting process.

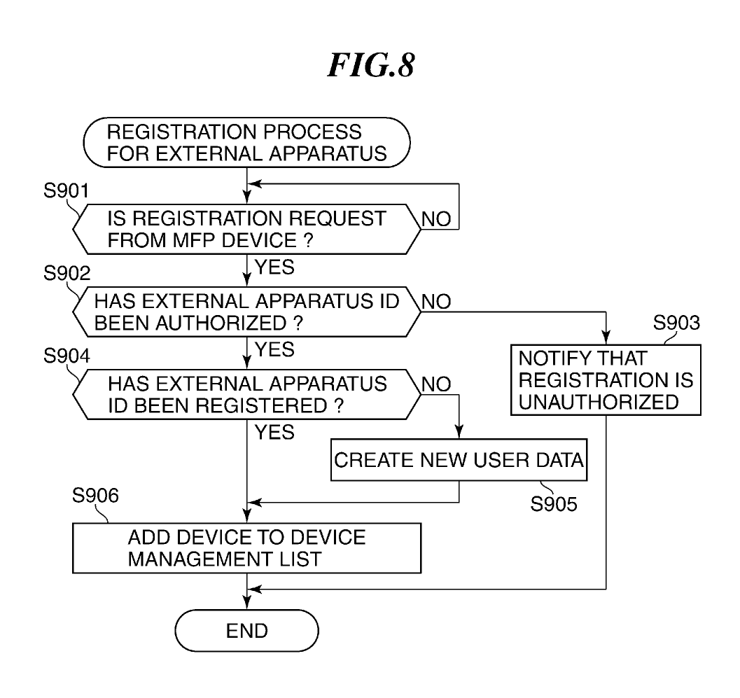

Next, a registration process for a printer device in the external apparatus in the external apparatus group 100 will be described with reference to a flowchart of FIG. 8.

In the registration process for the external apparatus, the CPU 201 waits for a registration request sent from the MFP device 6000 (NO in step S901). If the CPU 201 discriminates that the registration request arrives (YES in step S901), the CPU 201 proceeds to step S902.

Next, the CPU 201 discriminates whether or not the external apparatus ID in the registration request is an authorized ID. If the CPU 201 discriminates that the external apparatus ID is authorized (YES in step S902), the CPU 201 proceeds to step S904. Moreover, if the CPU 201 discriminates that the external apparatus ID in the registration request is an unauthorized ID, the CPU 201 proceeds to step S903. Here, it is assumed that the authorized ID has been previously set in the external apparatus.

Next, if the registration is unauthorized, the CPU 201 notifies the MFP device 6000 of the unauthorization of registration (step S903), and completes the registration process for the external apparatus.

Moreover, if the external apparatus ID in the registration request is the authorized ID, the CPU 201 discriminates whether or not the received external apparatus ID is a registered ID (step S904). Then, if the CPU 201 discriminates that the received external apparatus ID has been registered (YES in step S904), the CPU 201 proceeds to step S906, and if the CPU 201 discriminates that the received external apparatus ID has not been registered (NO in step S904), the CPU 201 proceeds to step S905. In this step S905, for example, new user data as follows is created.

In the user data to be created, when the external apparatus ID is 00000AAA1026, if the device name is Printer A, then the model is LBP8000, the IP address is 192.168.0.12, and the subnet mask is 255.255.255.0. Moreover, if the device name is Multifunction Peripheral B, then the model is IR3000, the IP address is 192.168.13.11, and the subnet mask is 255.255.255.0.

Next, the CPU 201 adds the device for which the registration request has been made, to a device management list in the user data (step S906), and completes the registration process for the external apparatus.

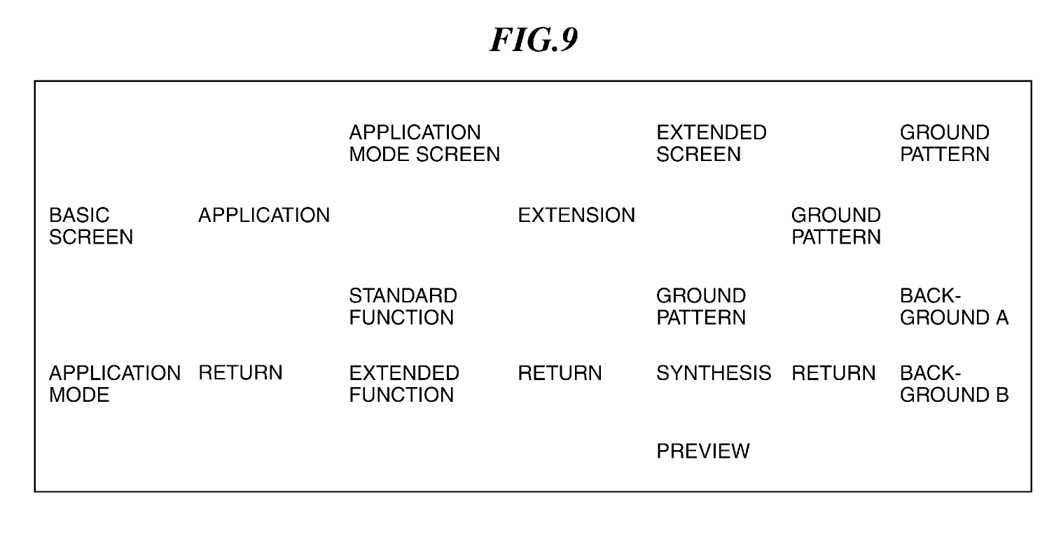

Next, an operation method on a display panel of the MFP device 6000 will be described with reference to FIG. 9.

While a basic screen is displayed or inputted on the display panel of this MFP device 6000, if setting of an extended function process is performed, the setting is performed from another screen (in an example of FIG. 9, the screen is changed by depressing an “EXTENDED FUNCTION” button). Content of this extended function setting screen is generated by the external apparatus group 100.

The CPU 312 of this MFP device 6000 receives information generated by the external apparatus group 100, and controls to display its display content provided by interpreting the information. Moreover, the CPU 312 of this MFP device 6000 transmits a command signal inputted at the display device to the external apparatus group 100, and then transits to a next screen. It should be noted that, needless to say, a method of displaying the screen and an aspect of the screen change which are shown in FIG. 9 are not limited thereto.

(Process in Printing)

Next, an outline of an example of a data flow between the MFP device 6000 and the external apparatus in the external apparatus group 100 will be described. In this example, the external apparatus (such as the directory server 1000 or the processing server A 2000 as shown in FIG. 1) in the external apparatus group 100 is used to perform the image processing. In this case, when the MFP device 6000 generates various jobs, the CPU 312 judges whether or not the print job includes the extended setting (extended function) for performing the image processing in the external apparatus.

Then, if the CPU 312 determines to cause the external apparatus to perform required image processing, the CPU 312 transmits the print job along with content of the extended setting to the external apparatus in the external apparatus group 100, and requests the external apparatus in the external apparatus group 100 to perform the image processing. When receiving this content of the extended setting and the print job, the external apparatus in the external apparatus group 100 performs an image generation process based on the content of the extended setting to generate the print image data, and transmits the image data to the MFP device 6000.

Here, if the extended setting is included, this extended setting is performed when the job is generated, and the setting is performed with the extended setting UI of the MFP. When the setting is performed, the external apparatus group 100 receives the extended setting UI information, display and input are performed in the MFP, and content of the setting is retained in this MFP or transmitted to the external apparatus group 100.

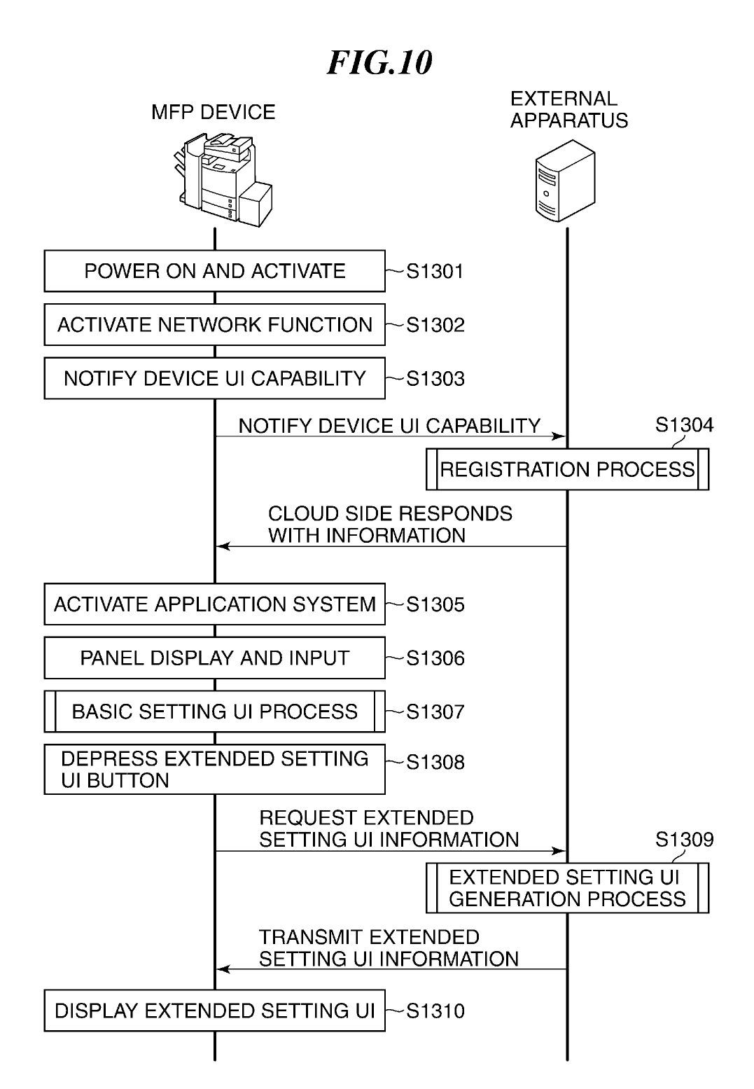

Next, in the printing system of the present embodiment, a specific example in a case where the external apparatus in the external apparatus group 100 performs a ground pattern process as the extended setting, and the MFP device 6000 performs an output process with the specified number of copies as basic setting will be described with reference to FIG. 10.

(Display Print Setting UI)

As shown in an explanatory drawing of FIG. 10 showing a data flow between this MFP device 6000 and the external apparatus in the external apparatus group 100, first, the MFP device 6000 is powered on and activated (step S1301).

Next, when a network function is activated (step S1302), the CPU 312 of the MFP device 6000 accesses the external apparatus group 100 which is the cloud, and notifies the external apparatus group 100 of its own UI capability information (step S1303).

When receiving the notification of the UI capability information on the MFP device 6000, the CPU 201 of the external apparatus registers the UI capability information (step S1304). Then, the CPU 201 of the external apparatus returns various kinds of information required for subsequent access from the MFP device 6000 to the external apparatus group 100, as a response.

Next, a flow in a case where the print process or the like is performed in the MFP device 6000 will be described. The CPU 312 of the MFP device 6000 activates an application for a copy operation or the like, based on a command through a panel input from the user (steps S1305 and S1306).

The CPU 312 of the MFP device 6000 performs processing parameter setting which is referred to in this application process, according to an instruction inputted through the display panel by the user (step S1307).

Here, if the user performs the extended setting using a function of the cloud (cloud computing), the user depresses an extended setting UI button (step S1308). Then, when receiving this command, the CPU 312 of the MFP device 6000 requests the external apparatus in the external apparatus group 100 for the extended setting UI information.

When receiving this request for the extended setting UI information, the CPU 201 of the external apparatus returns UI information depending on the capability of the device, to the MFP device 6000 (step S1309). Details of this return method will be described later.

When receiving the UI information, the CPU 312 of the MFP device 6000 interprets the information, displays a UI on the device panel, and continuously performs an input process or the like (step S1310).

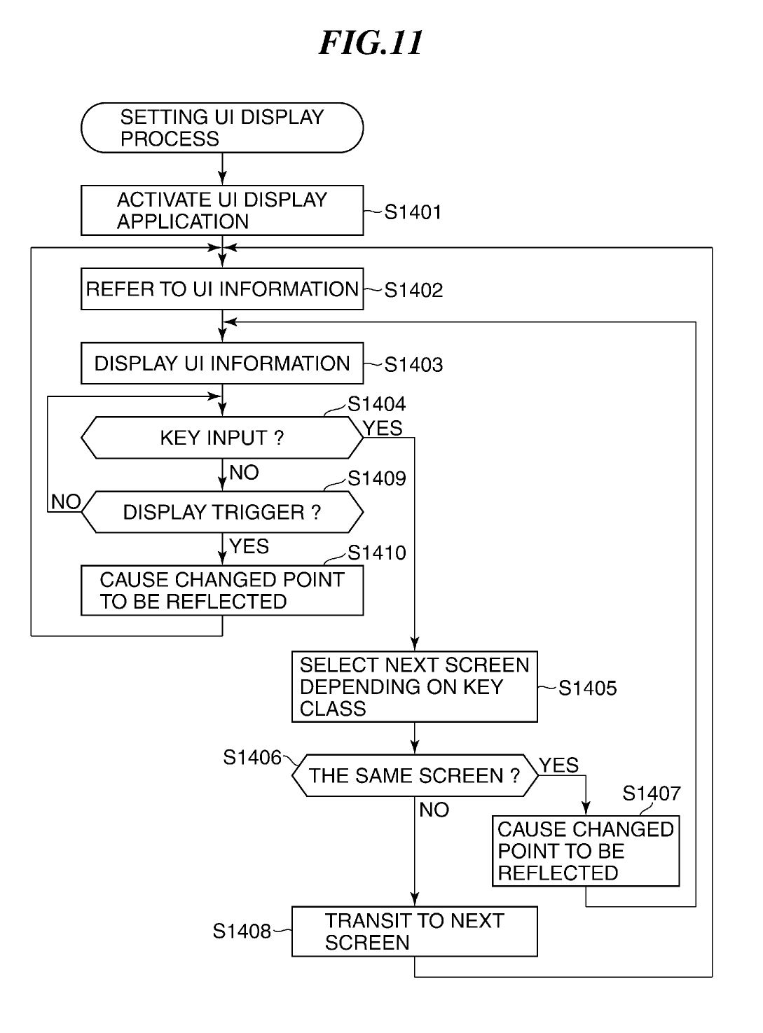

Next, a procedure of a setting UI display process executed by the CPU 312 of the MFP device 6000 will be described using a flowchart of FIG. 11. First, when the power is turned on, the CPU 312 activates a panel display application (step S1401), refers to the UI information on a UI initial screen (step S1402), and displays the UI information (step S1403). Then, the CPU 312 of the MFP device 6000 is put into a state where a key input from the display device is being waited for (steps S1404 and S1409).

Next, if there is the key input, the CPU 312 of the MFP device 6000 selects the next screen corresponding to a key class to perform reflection of the screen (step S1405). In this reflection of the screen, it is discriminated whether a part of the same screen is updated or the screen transits to another screen (step S1406). It is discriminated that a part of the same screen is updated (YES in step S1406), only a changed point is reflected (step S1407). Then, the CPU 312 is put into the key input waiting state (steps S1404 and S1409).

Moreover, It is discriminated that the screen transits to another screen based on a command through the key input (NO in step S1406), the CPU 312 causes the screen to transit to the next screen (step S1408).

Next, the CPU 312 refers to the UI information on another screen (step S1402), and performs the screen display according to the UI information (step S1403). Then, the CPU 312 displays the key input waiting state (steps S1404 and S1409) and waits for the key input.

On this display of the key input waiting state (steps S1404 and S1409), when a predetermined set time has elapsed, a display change trigger for changing the display is generated (for example, a display change flag is set). If the CPU 312 detects this display change trigger (YES in step S1409), the CPU 312 causes its changed point to be reflected (step S1410). Then, the CPU 312 refers to the UI information (step S1402), and performs the screen display according to the UI information (step S1403). Then, the CPU 312 displays the key input waiting state (NO in steps S1404 and S1409), and waits for the power to be turned off and the setting UI display process to be completed.

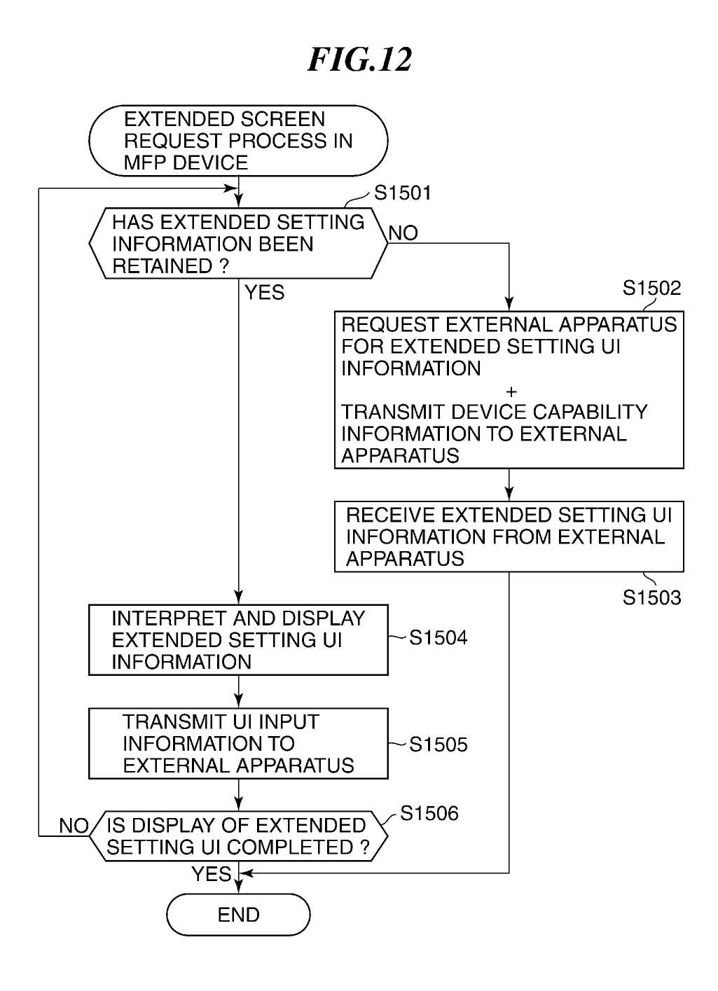

Next, a procedure of an extended screen request process of the MFP will be described with reference to FIG. 12.

This process is a process performed in step S1408 in the above described flowchart of FIG. 11. In this process in step S1408, it is judged whether the next screen transition exists within the MFP device 6000, or corresponds to performing display by using the extended setting provided by the external apparatus group 100. If the request is made to the external apparatus group 100, the process of this flowchart is performed.

When an extended screen is requested, the CPU 312 of the MFP device 6000 judges whether or not information on the extended screen (the extended setting UI information) has already been retained within the device (step S1501). Then, if the CPU 312 determines that the extended setting UI information is not retained (NO in step S1501), the CPU 312 requests the external apparatus in the external apparatus group 100, for the extended setting UI information, and also transmits its own device capability information to the external apparatus in the external apparatus group 100 (step S1502).

Next, the MFP device 6000 receives the extended setting UI information from the external apparatus (step S1503), and the CPU 312 interprets the information and displays content based on the information, on the display unit (step S1504).

Next, while the CPU 312 waits for the key input, if there is the input, the CPU 312 transmits the UI input information to the external apparatus (step S1505).

Next, the CPU 312 judges whether or not completion of the display of the extended setting UI has been instructed, based on the input information inputted by the user. Then, if the CPU 312 discriminates that the completion of the display of the extended setting UI has been instructed (YES in step S1506), the CPU 312 completes the extended screen request process and transits to a setting UI display state in the MFP device 6000.

Moreover, if the CPU 312 discriminates that the completion of the display of the extended setting UI has not been instructed (NO in step S1506), the CPU 312 returns to step S1501, and performs the display with next extended setting UI information according to the above described procedure.

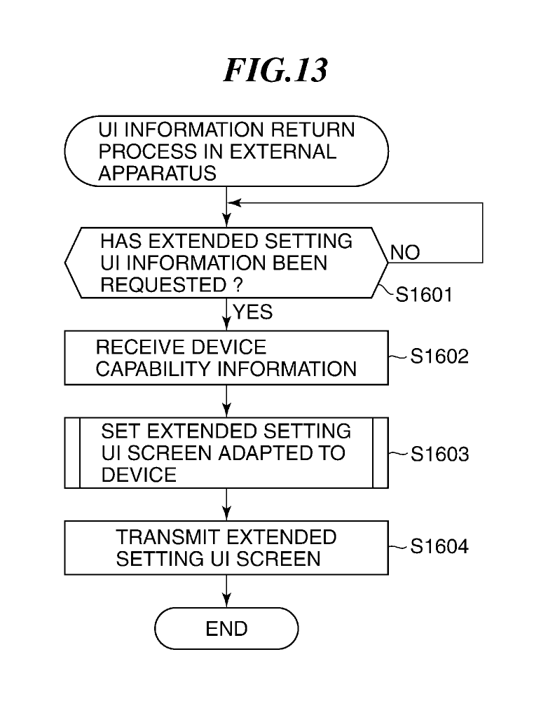

Next, a procedure of a UI information return process in the external apparatus will be described with reference to FIG. 13.

The external apparatus is in a process input waiting state which is a basic state (NO in step S1601). Moreover, if the external apparatus group 100 detects that the extended setting UI information has been requested (YES in step S1601), the external apparatus group 100 receives the device capability information (step S1602). Next, the CPU 201 generates an extended setting UI screen adapted to the device (step S1603), transmits generated UI screen information to the MFP device 6000 (step S1604), and completes this UI information return process.

(Print Process)

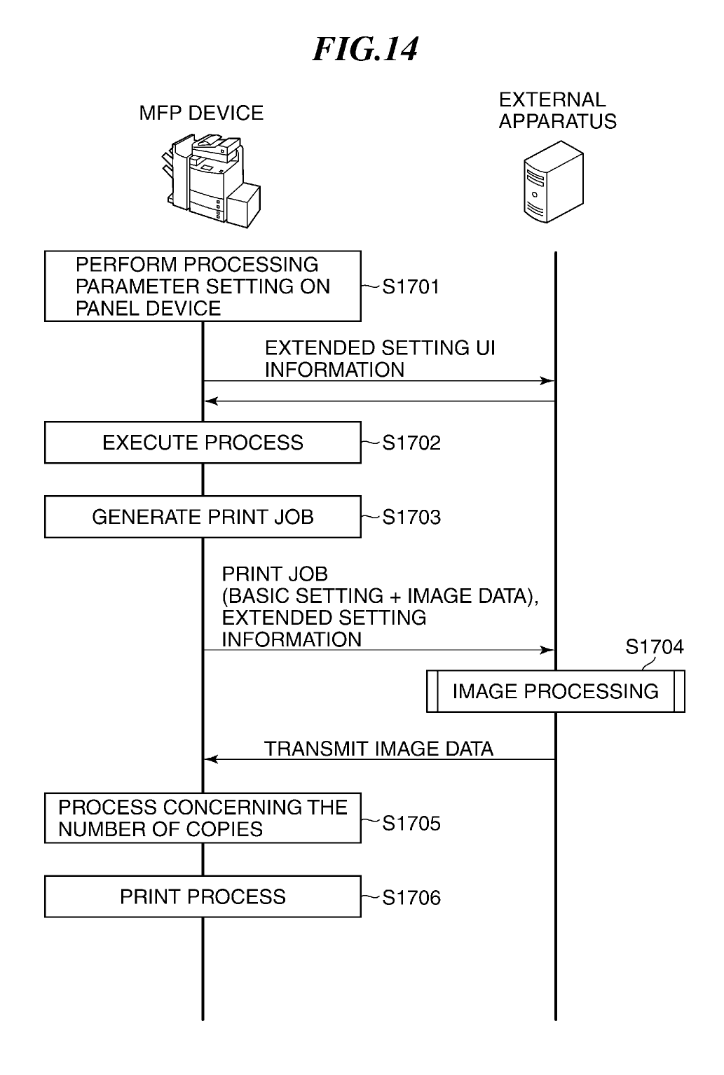

Next, a data flow between the MFP device 6000 and the external apparatus in the external apparatus group 100, mainly from when execution of the print process is instructed, to when the print process is completed, will be described with reference to FIG. 14.

In order to perform printing by using this printing system, the user operates the display panel to perform required setting on a print setting screen on the MFP (step S1701). In this example, as basic setting of a predetermined job ID, it is assumed that a paper size is set as “A4”, a paper type is set as “plain paper”, a print orientation is set as “longitudinal”, the number of copies is set as “2”, and “ground pattern” is set as the extended setting.

Next, when the user inputs the instruction to execute the printing, to the MFP device 6000, the print process is started (step S1702). Then, the MFP device 6000 generates the print job (step S1703). This print job includes the job ID, basic setting UI information (for example, the paper size of “A4”, “plain paper”, the print orientation of “longitudinal”, the number of copies of “2”, and “ground pattern” as the extended setting) and the print data. Moreover, extended setting information also includes the same job ID as the basic setting, and is associated with the print job. It should be noted that, if this extended setting information is exchanged as an HTML file, this extended setting information is transmitted as the HTML file to the MFP device 6000 based on a rule of an HTTP protocol. The reason why this extended setting information is transmitted as the HTML file to the MFP device 6000 in this way is that the external apparatus in the external apparatus group 100 generates a UI screen as screen display configuration information (an HTML file or the like), and this screen display configuration information is interpreted and displayed by a Web browser display function or the like on the display device on the MFP device 6000.

Next, the MFP device 6000 transmits the print job including the extended setting information and the basic setting information to the external apparatus in the cloud. When receiving this print job including the extended setting information and the basic setting information, the CPU 201 of the external apparatus refers to the extended setting information, performs the ground pattern process for the print job, and generates the print image data (step S1704). When the print image data is generated in this way, the external apparatus in the external apparatus group 100 transmits the image data to the MFP device 6000.

When receiving this image data, the MFP device 6000 performs a process concerning the number of copies based on content of the basic setting information (step S1705), and performs the print process (step S1706).

It should be noted that, in the above described steps S1705 and S1706, it has been described that the process concerning the number of copies which is the basic setting is performed on the device. However, a configuration may be employed in which, when the external apparatus which is the cloud generates the print image data, the external apparatus refers to the content of the basic setting and performs the generation of the image data (in this example, the process concerning the number of copies) based on the content of the basic setting.

The process in the MFP by using the external apparatus in the external apparatus group 100 has been described above. Next, an extended setting UI information generation method basic setting executed in the external apparatus in the external apparatus group 100 will be described.

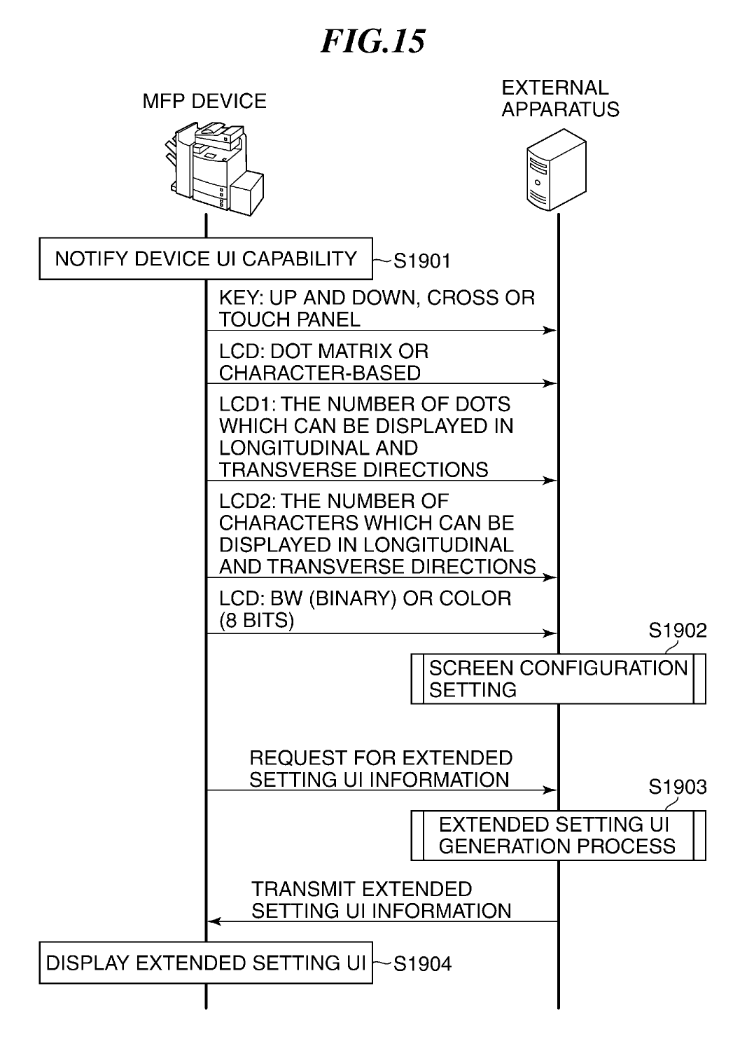

In this printing system, the CPU 312 of the MFP device 6000 notifies the external apparatus group 100 which is the cloud, of display capability of the MFP device 6000 (step S1901). As shown in FIG. 15, in addition to key input information, this capability information includes a format which can be displayed, the number of dots and the number of characters, a class of color display or black and white display, and the like. The external apparatus group 100 which is the cloud generates the extended setting UI on the external apparatus based on the received capability information (step S1902).

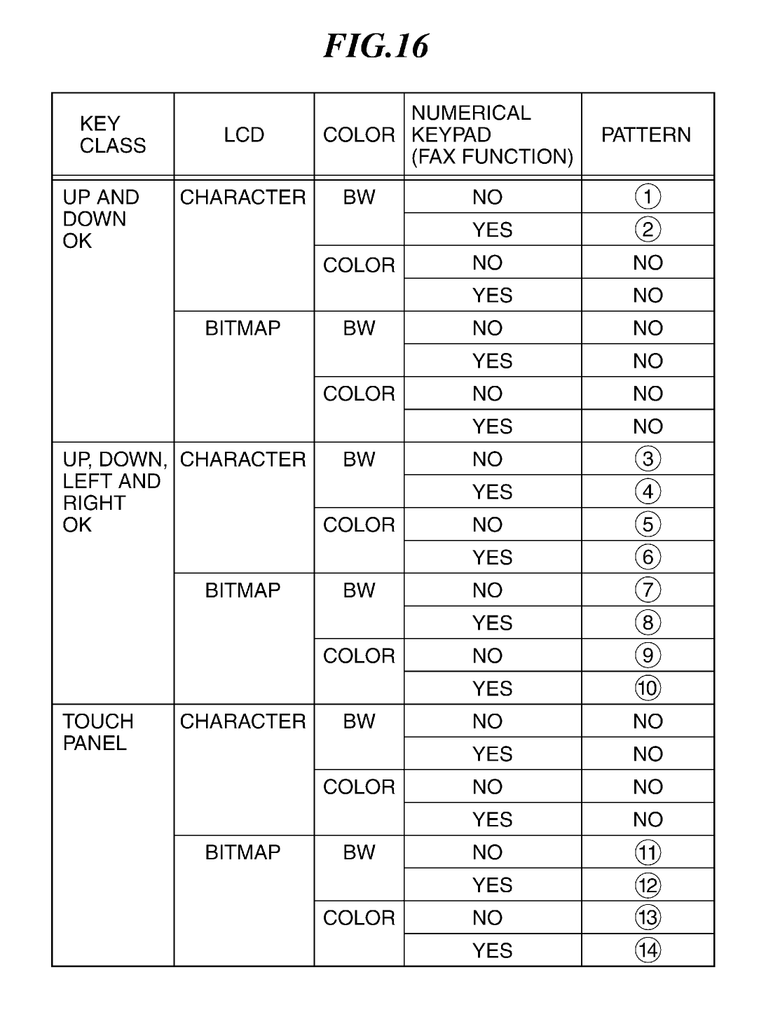

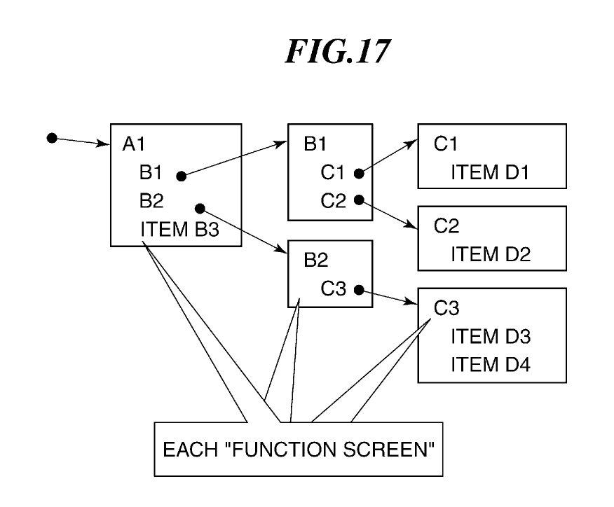

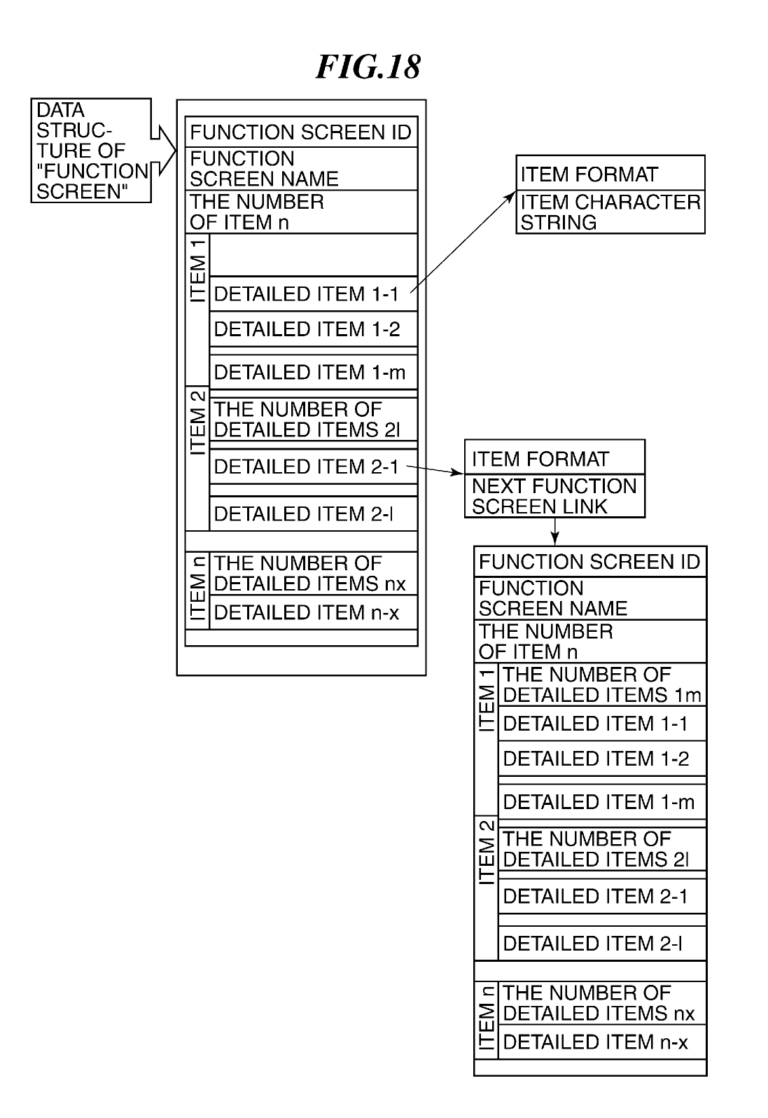

In this external apparatus in the external apparatus group 100, if the extended setting UI information is generated, the information is classified into several patterns depending on the capability of the device, and the generation method is controlled for each pattern. The discrimination process performed by the external apparatus group 100 is performed for items shown in FIG. 16. Moreover, in the external apparatus in the external apparatus group 100, a source of menu data in the control of the generation of the extended setting UI information is represented in metadata as shown in FIG. 17. This menu is represented in a tree format configured to include function screens and links. This function screen tree is the same for all device classes. A data structure of this function screen is as shown in FIG. 18.

The external apparatus in the external apparatus group 100 uses the data structure of this function screen to perform conversion for adaptation to the device class. In the conversion, this external apparatus in the external apparatus group 100 performs the conversion for each function screen. In this conversion, based on the above shown device display capability information and processing function capability information on the device, control of the conversion such as selection of a display item and decision of a setting item is performed. A detailed item in this function screen data structure is configured to include an item format and a member in the format.

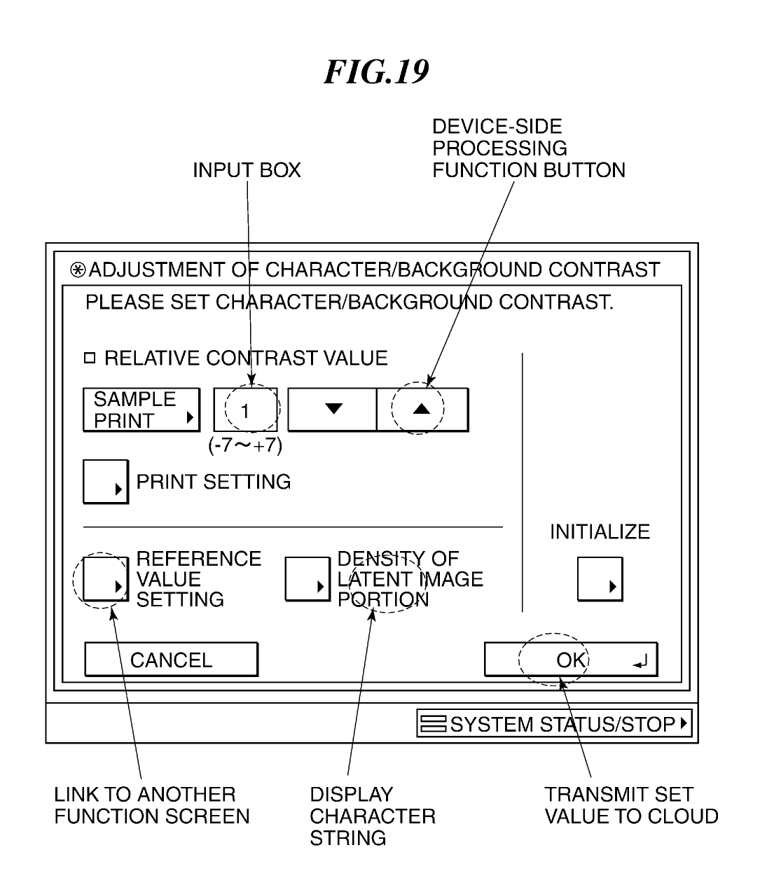

Next, this detailed item will be described with reference to FIG. 19 showing a display example of the UI for performing the processing parameter setting on the display device of the MFP device 6000.

On display of a UI (user interface) screen on the display device of this MFP device 6000, “LINK TO ANOTHER FUNCTION SCREEN” is a right pointing triangular button in the figure. This button is for switching a display screen according to menu hierarchical representation.

“DISPLAY CHARACTER STRING” in the display of this UI screen is for displaying a character string of a setting item name. “INPUT BOX” shown in FIG. 19 is a field on a white background, and is configured so that a value of the setting item being set can be displayed and inputted. “DEVICE-SIDE PROCESSING FUNCTION BUTTON” is a + button and a − button, a ↑ button and a ↓ button, or the like for changing the value being set and changing a number in the input box (This input process is performed by the MFP device 6000.). Moreover, “TRANSMIT SET VALUE TO CLOUD” is an OK button and a cancel button for transmitting the set value from the MFP device 6000 to the external apparatus group 100.

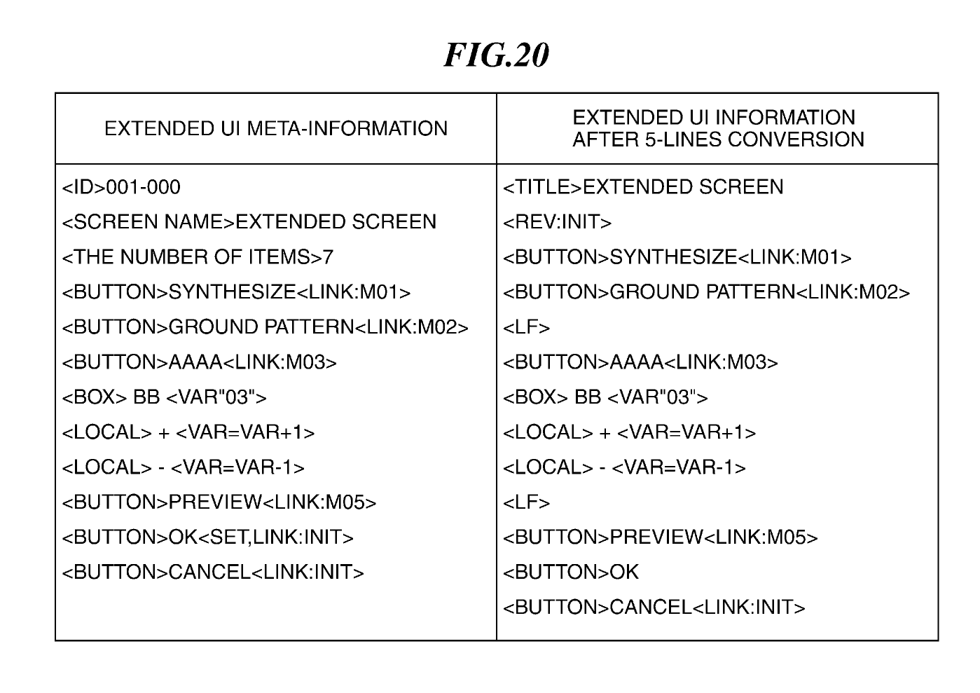

Since the adaptation to the device class is performed by the external apparatus group 100 which is the cloud as described above, a result of converting extended UI meta-information into extended UI information is as shown in FIG. 20.

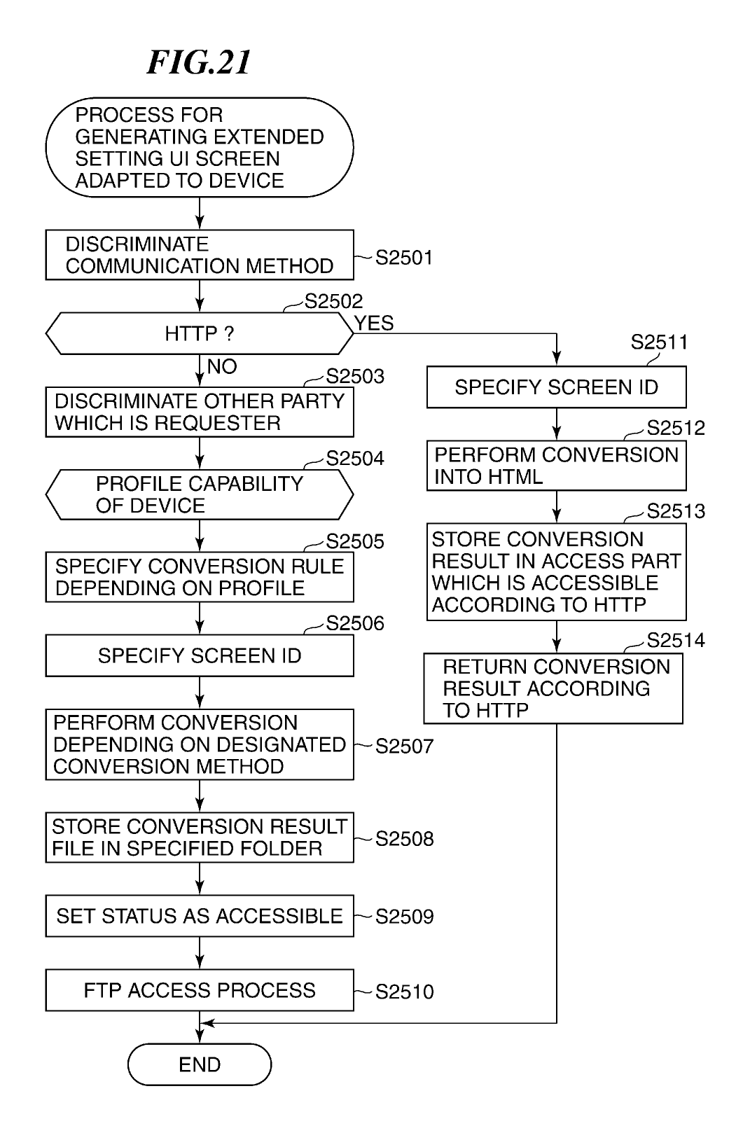

Next, a procedure when the extended UI information is converted in the external apparatus in the external apparatus group 100 will be described with reference to a flowchart of FIG. 21. Here, an example in a case where the external apparatus in the external apparatus group 100 uses the HTTP protocol will be described.

In order to receive a request for generation of an extended UI, the CPU 201 which is a control unit of the external apparatus in the external apparatus group 100 discriminates a communication method for the request (step S2501). If the CPU 201 which is the control unit of the external apparatus determines that access is not HTTP access (NO in step S2502), the CPU 201 proceeds to step S2503 and discriminates the other party which is a requester.

Since the MFP device 6000 has already been registered in the external apparatus, the capability information on the device is specified with reference to the registration information. Next, the CPU 201 which is the control unit of the external apparatus profiles the capability of the device based on the specified capability information, and specifies a rule of a conversion process to be performed next (step S2505). Then, the CPU 201 of the external apparatus performs conversion of an extended UI screen and a screen of the ID from metadata, as designated in the request (step S2507). A result of this conversion is defined to be in a file format, and is stored in a folder which is referred to when a file is accessed (step S2508).

Next, the CPU 201 which is the control unit of the external apparatus sets status information for performing FTP access from the MFP, as “accessible” (step S2509). In other words, if the CPU 201 determines that the access is not the HTTP access, the CPU 201 specifies the rule of the conversion process based on the capability information on the MFP device 6000, and converts the information. The information converted in this way is stored in the file format in the folder which is referred to when the file is accessed, so that the file is set to be accessible according to an FTP protocol.

Then, the CPU 201 which is the control unit of the external apparatus waits for the FTP access, performs a process for an FTP command “GET” (step S2510), and completes this extended setting UI screen generation process.

Moreover, if the CPU 201 determines in the above described step S2502 that the access is the HTTP access (YES in step S2502), the CPU 201 proceeds to step S2511 and specifies a screen ID.

Next, the CPU 201 performs the conversion into HTML (step S2512). A result of this conversion is stored in an access part which is accessible according to HTTP (step S2513). Furthermore, the CPU 201 returns this conversion result to the MFP device 6000 according to the HTTP protocol (step S2514), and completes this extended setting UI screen generation process. In other words, if the CPU 312 of the MFP device 6000 determines that there is a WEB browser function, the CPU 312 configures a WEB server to be accessible according to the HTTP protocol. Then, an HTML file provided by converting information used in the WEB server, into the HTML file, is transmitted to the MFP device 6000 based on the rule of the HTTP protocol, and this extended setting UI screen generation process is completed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2010-174565 filed Aug. 3, 2010, which is hereby incorporated by reference herein in its entirety.

What is claimed is:

1. An information processing apparatus configured to be connectable to an image forming apparatus via a network, comprising:
a communication unit configured to transmit and receive data;
a discrimination unit configured to discriminate a function included in the image forming apparatus, based on processing capability information received by said communication unit;
a generation unit configured to generate screen information used for setting an extended function, depending on the function included in the image forming apparatus which has been discriminated by said discrimination unit;
a receiving unit configured to receive extended setting information inputted through a screen displayed on the image forming apparatus based on the screen information generated by said generation unit, from the image forming apparatus;
an image processing unit configured to apply image processing to print data received from the image forming apparatus, based on content of the extended setting information received by said receiving unit; and
a transmission unit configured to transmit the print data applied with the image processing by said image processing unit, to the image forming apparatus.

2. The information processing apparatus according to claim 1, wherein
said generation unit is configured to, based on display capability information and processing function capability information on the image forming apparatus, select a display item and decide a setting item, convert the display item and the setting item for each function screen, and generate the screen information adapted to a class of the image forming apparatus.

3. The information processing apparatus according to claim 1, wherein
a control unit included in the information processing apparatus is configured to:
if it is determined that the image forming apparatus has a WEB browser function, configure a WEB server to be accessible according to an HTTP protocol, convert information used in the WEB server into an HTML file, and transmit the HTML file to the image forming apparatus based on the HTTP protocol, and
if it is determined that an access to the information processing apparatus is not the access according to the HTTP protocol, specify a rule of a conversion process based on the capability information on the image forming apparatus, convert the information, and store a result of the conversion, in a file format in a folder which is referred to when a file is accessed, so that the file is set to be accessible according to an FTP protocol.

4. An image forming apparatus configured to be connectable to an external apparatus via a network, comprising:
a communication unit configured to transmit and receive data;
a retaining unit configured to retain processing capability information indicating a function included in the image forming apparatus;
a first transmission unit configured to transmit the processing capability information retained in said retaining unit to the external apparatus;
a receiving unit configured to receive screen information used for setting an extended function, from the external apparatus;
a display unit configured to display a screen used for setting the extended function, based on the screen information received by said receiving unit;
a second transmission unit configured to transmit extended setting information indicating content of extended setting inputted through the screen displayed on the display unit, and print data, to the external apparatus; and
an image forming unit configured to receive print data created by the external apparatus applying image processing to the print data transmitted by said second transmission unit, and perform image forming by using the received print data.

5. A method of controlling an information processing apparatus configured to be connectable to an image forming apparatus via a network, comprising:
a communication step of transmitting and receiving data;
a discrimination step of discriminating a function included in the image forming apparatus, based on processing capability information received in said communication step;
a generation step of generating screen information used for setting an extended function, depending on the function included in the image forming apparatus which has been discriminated in said discrimination step;
a reception step of receiving extended setting information inputted through a screen displayed on the image forming apparatus based on the screen information generated in said generation step, from the image forming apparatus;
an image processing step of applying image processing to print data received from the image forming apparatus, based on content of the extended setting information received in said reception step; and
a transmission step of transmitting the print data applied with the image processing in said image processing step, to the image forming apparatus.

6. A method of controlling an image forming apparatus configured to be connectable to an external apparatus via a network, comprising:
a communication step of transmitting and receiving data;
a retaining step of retaining processing capability information indicating a function included in the image forming apparatus;
a first transmission step of transmitting the processing capability information retained in said retaining step to the external apparatus;
a reception step of receiving screen information used for setting an extended function, from the external apparatus;
a display step of displaying a screen used for setting the extended function, based on the screen information received in said reception step;
a second transmission step of transmitting extended setting information indicating content of extended setting inputted through the screen displayed in said display step, and print data, to the external apparatus; and
an image forming step of receiving print data created by the external apparatus applying image processing to the print data transmitted in said second transmission step, and performing image forming by using the received print data.

7. A non-transitory computer-readable storage medium configured to store a program causing a computer to implement a method of controlling an information processing apparatus configured to be connectable to an image forming apparatus via a network according to claim 5.

8. A non-transitory computer-readable storage medium configured to store a program causing a computer to implement a method of controlling an image forming apparatus configured to be connectable to an external apparatus via a network according to claim 6.
